(19) United States
(12) Patent Application Publication
(10) Pub. No.: US 2026/0022790 A1
(43) Pub. Date: Jan. 22, 2026

(54) PLUG CONNECTOR FOR CONNECTING PIPES FOR LIQUID OR GASEOUS MEDIA

(71) Applicant: Henn GmbH & Co KG., Dornbirn (AT)

(72) Inventors: Florian KUHLHOFF, Hamburg (DE); Amin ELTAIF, Hamburg (DE); Lukas HALBEISEN, Weiler (AT)

(73) Assignee: Henn GmbH & Co KG., Dornbirn (AT)

(21) Appl. No.: 18/997,863

(22) PCT Filed: Jul. 25, 2023
(86) PCT No.: PCT/AT2023/060249

§ 371 Date: Jan. 23, 2025

(30) Foreign Application Priority Data
Jul. 25, 2022 (AT) A 50558/2022

(51) Int. Cl. F16L 37/084; F16L 37/12

(52) U.S. Cl. CPC F16L 37/0847; F16L 37/12

(57) ABSTRACT

A reversibly-releasable coupling for a plug-in connection on pipes and hoses, for connection to a tubular plug having at least one latching shoulder or edge running at least partially around the outer circumference, includes at least one locking element assuming, when the plug is fully inserted, a locking position where a locking section is pivoted towards the plug and, via a locking edge, fixedly engages behind the plug locking shoulder or edge. The section lies completely inside the locking ring, axially releasing it. An elastic element presses the ring axially from an open into a locking position completely overlapping the section. The locking element is pivotable about an axis relative to the coupling sleeve between open and locking positions. It has a lever-like portion extending in the circumferential direction of, and latched in the open position relative to, the sleeve. Inserting the plug releases the portion from the latched position.

The invention relates to a reversibly releasable coupling for a plug-in connection on pipes and hoses according to the preamble of claim 1.

DE 102005044751 A1 discloses an exemplary plug connector for the locked and sealed plug-in connection of media lines. The connector consists of a receiving part with a receiving opening for a receiving section on the line side. Holding means and sealing means are provided in the area of the receiving opening for locking or sealing against the circumferential surface of the insertion section. The receiving part consists of two parts surrounding the receiving opening, wherein the holding means are arranged on the inner part. This can be moved axially relative to the base part between a first and a second position, wherein in cooperation with the base part in the first position a free inner cross-section greater than/equal to the outer cross-section of the circumferential surface of the insertion section is kept free in the area of the holding means. In the second position, which is offset in the insertion direction, the holding means are moved radially inwards to engage against the circumferential surface of the insertion section.

WO 2021185419 A1 discloses a reversibly releasable fluid line coupling whose latching state can be easily controlled automatically and preferably optically. The coupling comprises a coupling sleeve, a locking element and a coupling plug with a locking collar, wherein the locking element assumes a locking position when the plug is fully inserted, in which a locking section is pivoted towards the plug and interacts with a locking shoulder or locking edge of the plug in a fixing manner. The outside of the locking section is shifted to the inside of the coupling sleeve so that it lies inside the locking ring. The locking elements have actuating and/or signaling surfaces that are only visible when the coupling is not locked. The locking ring can be moved axially by at least one elastic element from an open position into a locking position that completely overlaps the locking element as soon as the locking element is in the locking position.

The object of the present invention was to overcome the disadvantages of the state of the art and to provide a device which consists mainly of plastic parts and yet ensures secure locking of the fluid lines and their tightness under temperature load.

This object is achieved with the device according to the claims.

The device according to the invention is characterized in that the locking element is adjustable relative to the coupling sleeve between an open position and the locked position and has at least one lever-like section extending from the locking element, which is latched relative to the coupling sleeve in the open position, wherein the lever-like section projects into the insertion path of the latching shoulder or latching edge on the plug distant from the locking section and is released from the latched position at the latest when the plug is fully inserted. Preferably, the locking element can be pivoted about a tangential pivot axis relative to the coupling sleeve between an open position and the locking position, which facilitates the possibility of exerting a holding effect on the locking ring via the locking element.

An advantageous embodiment of the invention is characterized in that the pivot axis of the locking element lies in its central section and the section opposite the locking section with respect to this pivot axis has a bevel or elevation, and in that the locking ring has an elevation on its inner side which acts radially on the bevel or elevation of the locking element when the locking ring is pushed into the open position against the action of the at least one elastic element.

According to a further variant of the embodiment of the invention, in which the locking elements and the locking ring hold each other in the open position, the pivot axis of the locking element lies also in its central section and the section opposite the locking section with respect to this pivot axis has a projection projecting radially outwards, and the locking ring has a shoulder on its inner side which acts axially on the projection when the locking ring is pushed into the open position against the action of the elastic element.

An embodiment in which the lever-like section extending from the locking element runs in the circumferential direction of the coupling sleeve is advantageous for a compact design of the coupling.

Preferably, the coupling sleeve has a latching nose or latching edge on the outside, and the lever-like section engages behind this latching nose or latching edge in the open position of the locking element.

According to a further embodiment according to the invention, the locking ring acts on the locking element in its open position and holds it in the open position. Alternatively or additionally, the locking element also holds the locking ring in its open position.

Alternative or in addition to the features of the previous section, this embodiment is preferably characterized in that the locking element preferably engages behind the upper edge of the locking ring in the open position with a locking nose pointing radially outwards at the height of the locking section or engages in openings in the upper, circumferential edge section and axially fixes the locking ring.

A further embodiment of a coupling according to the invention is characterized in that at least two locking elements are preferably evenly distributed around the circumference of the coupling sleeve, wherein the lever-like sections of adjacent locking elements overlap with their end sections.

A further optional feature of the invention consists in that an elevation is arranged on the coupling sleeve at the height of the central section of the locking element, against which elevation the inside of the central section of the locking element abuts and which thus defines the pivot axis.

In order to enable the coupling to be attached to the end of a pipe or hose quickly and without tools, an advantageous embodiment of the invention is characterized in that there is a latching connection between the coupling sleeve and the pipe or hose.

Preferably, at least one locking edge is configured on the coupling sleeve, which engages behind an undercut on the pipe or hose.

In an advantageous way, a rotation lock may be provided between the pipe or hose and the coupling sleeve.

A particularly advantageous further embodiment of the invention is characterized in that at least one snap arm is arranged on the locking ring, the free end of which arm facing the plug can be elastically deflected radially outwards, wherein the free end is supported on a latching edge of the coupling sleeve in the open position of the locking ring, and wherein the free end is brought out of engagement with the coupling sleeve by the locking element in the locking position of the locking element. This means that the locking mechanism cannot be triggered unintentionally, for example by carelessly touching the locking ring. Thanks to the design according to the invention, the snap arm supports the locking ring directly on the coupling sleeve in the open/unlocked state and thus relieves the locking element, which now does not have to additionally support the locking ring.

Preferably, such a coupling has a coupling sleeve which has at least one latching edge oriented towards the pipe for supporting the free end of the snap arm, wherein the snap arm, in its open position, holds the locking ring in its open position.

A preferred embodiment of a coupling according to the invention is one in which the coupling sleeve, the locking element and the locking ring, optionally also the elastic element, are made at least predominantly of plastic. Preferably, the components listed are made entirely of plastic. As the coupling design described above means that no plastic components are deformed in either the open or inserted position, creep of the components under temperature load can be avoided.

For a better understanding of the invention, it is explained in more detail with the aid of the following figures.

The figures show a simplified, schematic representation as follows:

FIG. 1 a partial sectional side view of a first embodiment of a coupling according to the invention according to the VDA standard in the open position.

FIG. 2 a view corresponding to FIG. 1 in the inserted and locked position.

FIG. 3 a further embodiment of a coupling according to the invention according to the VDA standard in partial sectional side view and in the inserted and locked position.

FIG. 4 a partial sectional side view of a further embodiment of a coupling according to the invention according to the SAE standard in the open position.

FIG. 5 a detailed view on an enlarged scale of the latching connection of the coupling sleeve and pipe or hose.

FIG. 6 a partial sectional side view of the embodiment of FIG. 4, showing further details.

FIG. 7 an exploded view of the pipe end and coupling sleeve of a further embodiment of a coupling according to the invention according to the SAE standard.

FIG. 8 a perspective view of a pipe end according to an embodiment of the invention.

FIG. 9 a perspective view of a coupling sleeve according to an embodiment of the invention for use with a pipe end according to FIG. 8.

FIG. 10 a perspective view of a locking ring according to a further embodiment of the invention.

FIG. 11 a perspective view of two opposing locking elements according to a further embodiment of the invention for use with a coupling sleeve according to FIG. 9 and a locking ring according to FIG. 10.

FIG. 12 a longitudinal section through an embodiment of the invention using the elements of FIGS. 8 to 11 with the plug partially inserted and in the plane of the inner projections of the locking ring.

FIG. 13 a longitudinal section through the embodiment of FIG. 12 in a plane with at least one snap arm.

FIG. 14 a longitudinal section through an embodiment of the invention using the elements of FIGS. 8 to 11 with the plug completely inserted and locked and in the plane of the inner elevations of the locking ring.

FIG. 15 a longitudinal section through the embodiment of FIG. 14 in a plane with at least one snap arm.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

### DESCRIPTION OF THE FIGURES

FIG. 1 shows an exemplary first embodiment of a reversibly releasable coupling according to the invention, as it may be used for a plug-in connection on pipes 3 or hoses. The coupling can be used to seal and lock a tubular plug 1, which is shown here as an example in a version required by the VDA (Verband der Automobilindustrie), to the pipe 3 or hose. Such plugs 1 have at least one latching shoulder or latching edge 2 running at least partially around the outer circumference, which is preferably formed from a bevel rising from the outer circumference on the plug side and a latching surface adjoining therebehind with respect to the outer circumference on the plug side.

A coupling sleeve 4 is mounted on the pipe 3 or integrally configured at its end, into which the plug 1 is inserted and in which it is then held secured against removal by at least one locking element 5. A locking ring 6 engages around the coupling sleeve 4 and the locking elements 5 held therein or thereon and is axially shiftable along the coupling sleeve 4 between an open position and a locking position, wherein at least one elastic element 8, preferably a helical spring also engaging around the coupling sleeve 4, acts on the locking ring 6 in the direction of the locking position.

FIG. 1 shows the arrangement of the plug 1 and the coupling, comprising at least the coupling sleeve 4, at least one locking element 5, the locking ring 6 and at least one elastic element 8, in the as-delivered state, at the beginning of the production of the sealed plug-in connection. The plug 1 is already inserted into the coupling sleeve 4 to such an extent that a cam 22 on its outer side is pushed into a complementary recess 23 in the coupling sleeve 4, thus creating a rotation lock. The cam 22 may overlap with the latching shoulder or latching edge 2 on the plug 1. The front end of the plug 1 is already covered by a seal 21, preferably a profiled lip seal, which is held in a receiving groove in the front edge area of the pipe 3 or hose. If necessary, one or more O-rings may also be used to protect against twisting and reduce the joining force. This is particularly intended for couplings designed according to SAE (Society of Automotive Engineers).

The coupling sleeve 4 is placed as a separate component on the front end of the pipe 3 and is preferably fixed there by a latching connection 16, 17. At least one radially inwardly projecting latching nose or a latching edge 16 is configured in the lower edge area of the coupling sleeve 4, possibly at the lower end of at least one elastically radially deflectable snap hook 24, as shown in the embodiment shown in FIG. 3. The latching edge 16 engages behind an undercut 17 or a limited latching projection on the pipe 3 or hose and thus fixes the coupling sleeve 4 in the axial direction.

The latching edge 16 may be completely circumferential or arranged in partial sections on elastically deflectable snap hooks 24 distributed around the circumference of the coupling sleeve 4, as may be clearly seen in the exploded view in FIG. 7. At the height of the latching edge 16 or at the lower end of the snap hooks 24, a collar 25, if necessary a section thereof on each snap hook 24, or a group of projections is arranged projecting radially outwards. To prevent the latching connection from springing open, the distance between the inner wall of the locking ring 6, in particular its section reaching the height of the latching connection, and the collar 25 is smaller than the overlap between the latching edge 16 and the undercut 17 on the pipe 3 or hose, so that a radial deflection of the latching edge 16 releasing the latching edge 16 is prevented by a previous stop on the locking ring 6. This design and the size ratios described may be seen particularly clearly in the enlarged detailed view in FIG. 5.

Just as an rotation lock may be provided between the plug 1 and the coupling sleeve 4, it is also possible to install an rotation lock between the coupling sleeve 4 and the pipe 3 or hose. An exemplary embodiment is also shown in FIG. 7. Guide ridges 26 extending in the longitudinal direction of the pipe 3 are arranged between the nose-like sections of the undercut 17 distributed circumferentially at the end of the pipe 3. The snap hooks 24 at the lower, pipe-side end of the coupling sleeve 4 are distributed around the circumference of the coupling sleeve 4, wherein a space is kept free between the adjacent snap hooks 24, which acts as a guide gap 27 and into which the guide ridges 26 engage when the coupling sleeve 4 is pushed onto the pipe end. Discrete angular positions between the pipe 3 and the coupling sleeve 4 may be specified as required via the number and angular spacings between the guide ridges 26 or guide gaps 27. The alignment of the coupling head in the circumferential direction should be as freely selectable as possible. The latching geometry on the media-carrying nozzle may be specified in the injection mold during production, so that a free angular position is possible.

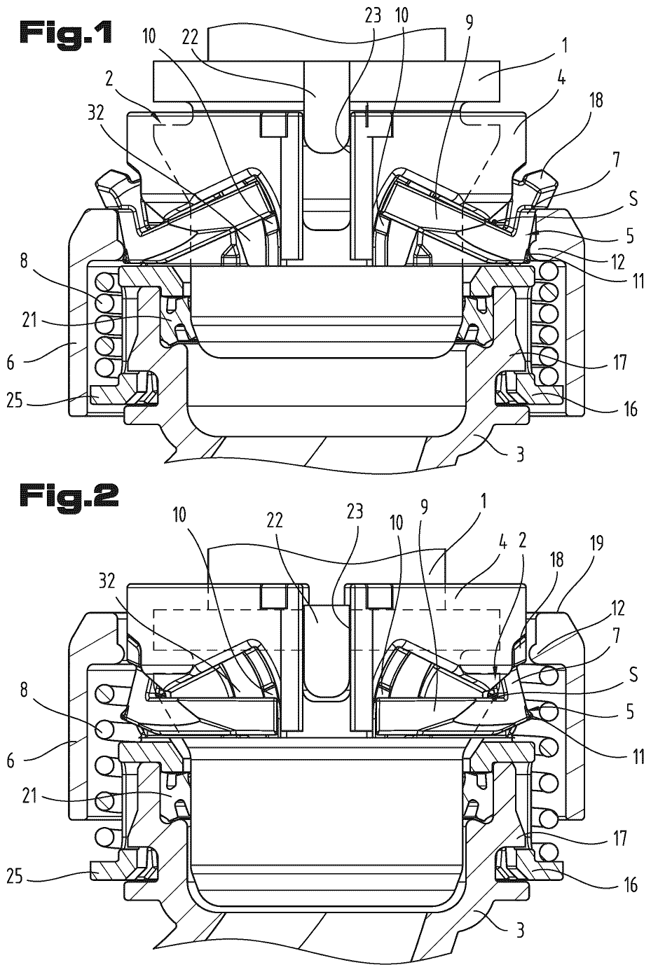

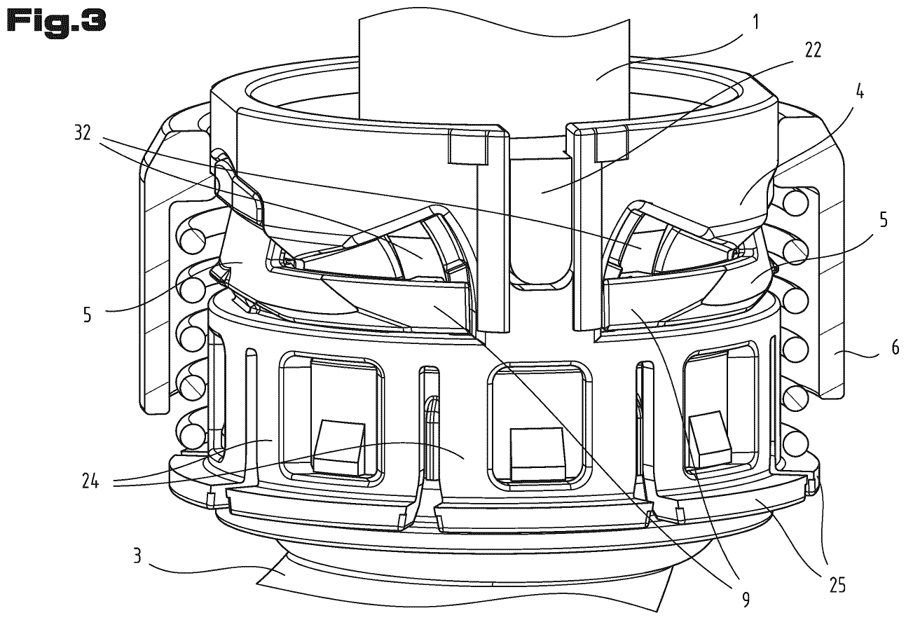

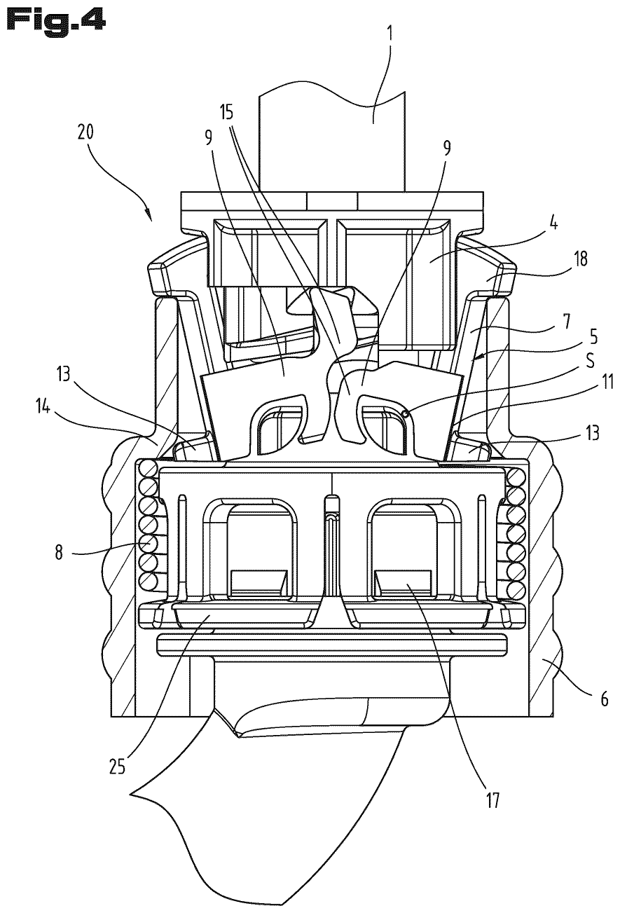

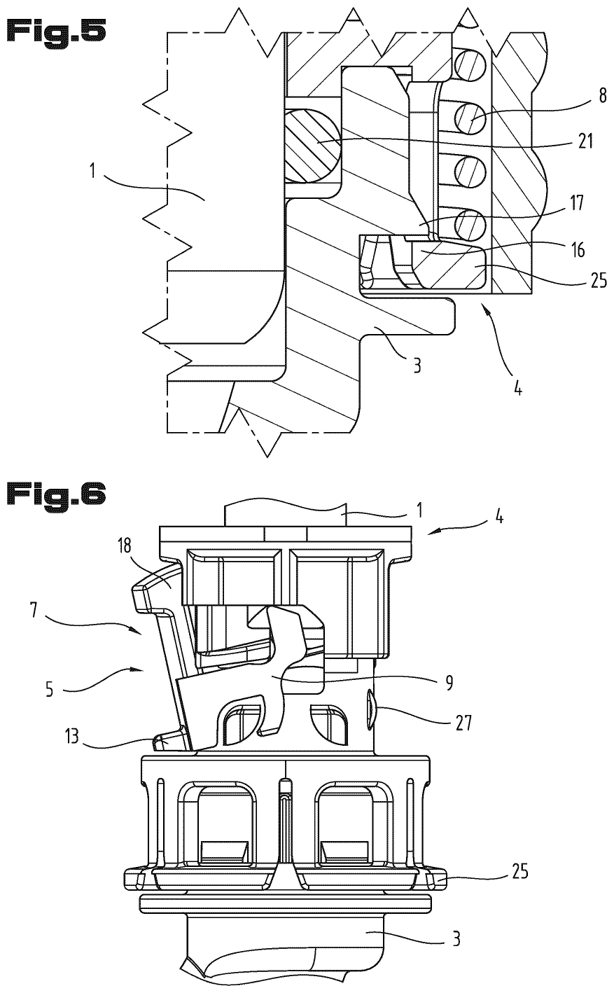

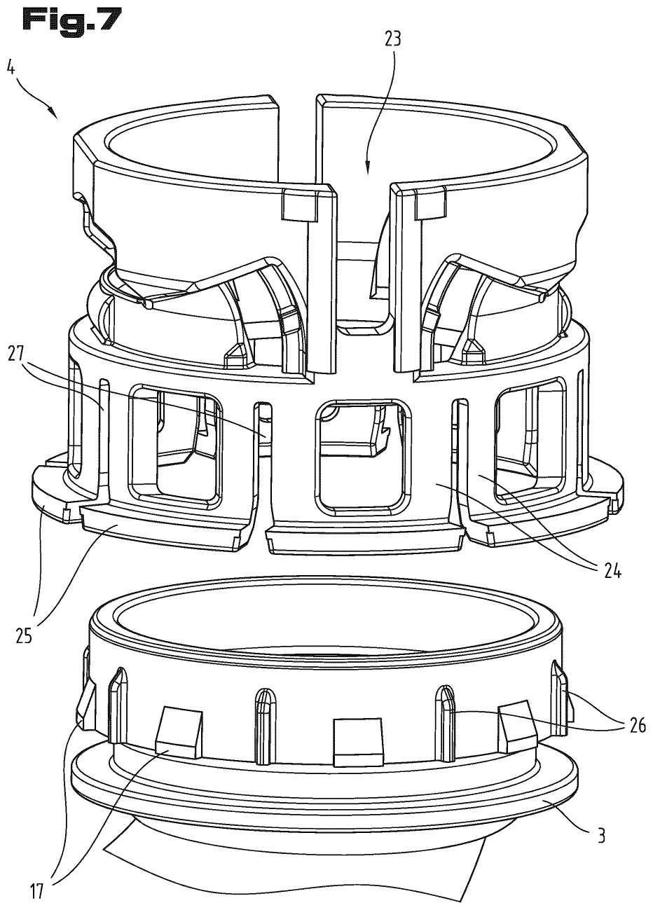

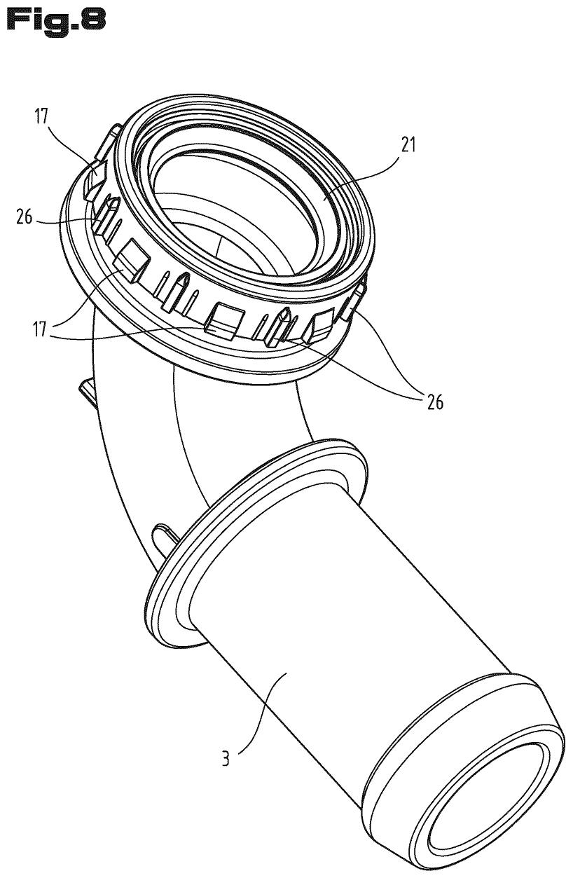

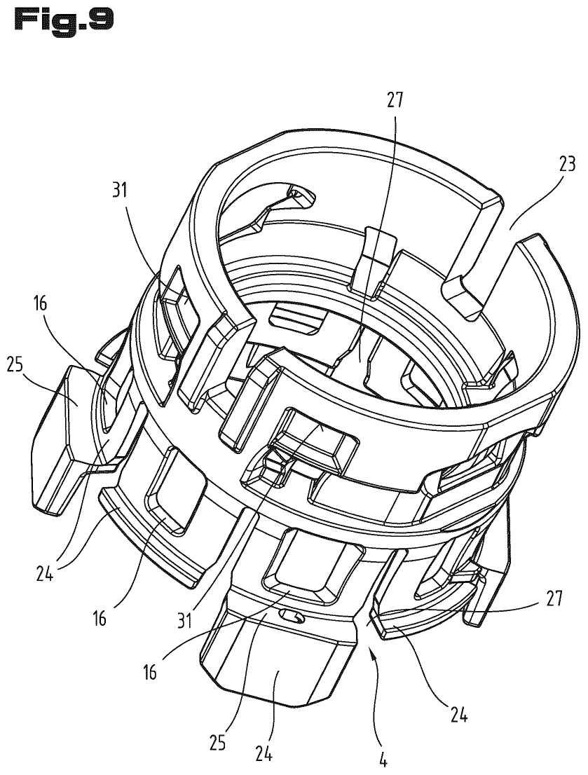

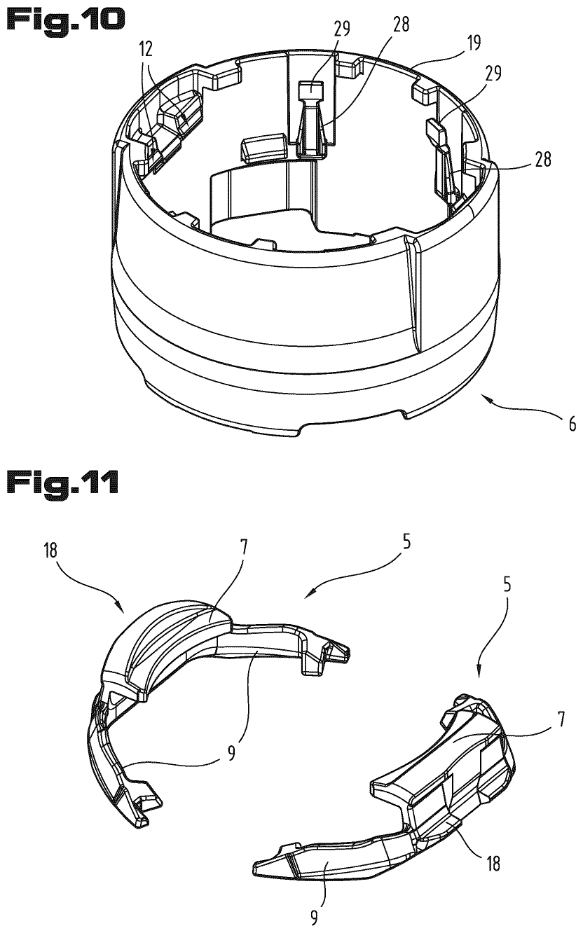

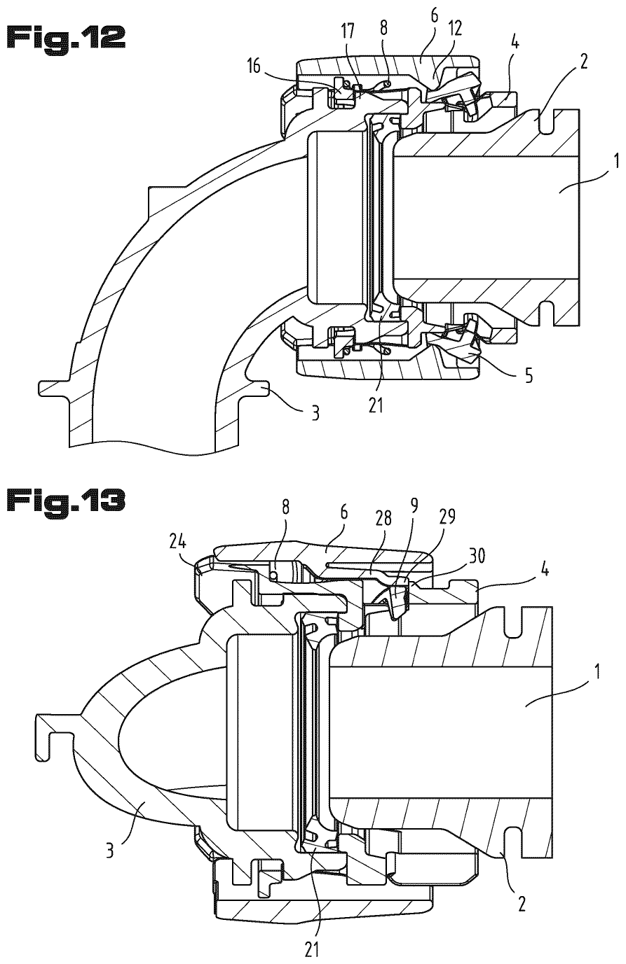

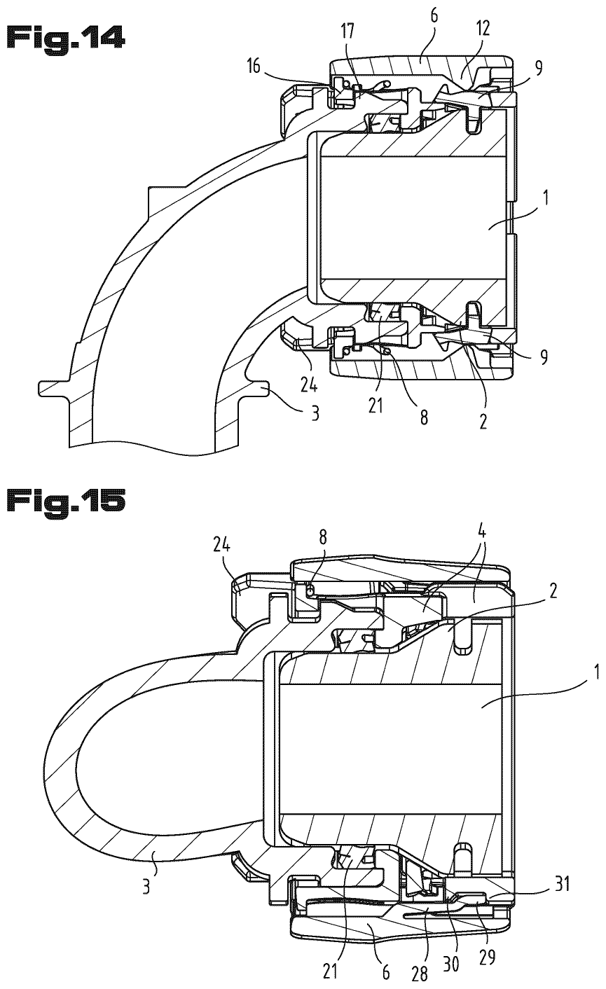

FIG. 1 also shows one of preferably several locking elements 5 in its open position, in which the plug 1 can be inserted unhindered into the coupling sleeve 4. For this purpose, the axially extending locking section 7 is pivoted away from the plug 1, preferably with a locking edge projecting radially inwards towards the plug 1.

On the outside of the locking element 5, preferably at the height of the locking section 7, a radially outwardly pointing latching nose 18 is configured, which in the open position shown in FIG. 1 engages behind the upper edge 19 of the locking ring 6. An alternative embodiment could also provide an opening for each locking element 5 in the upper, circumferential edge section 20 of the locking ring 6, into which the latching nose 18 engages. In this way, the locking ring 6 is axially fixed by the locking element 5 in its open position shifted in the direction of the pipe 3 and against the effect of the elastic element 8.

In return, however, the locking ring 6 may also act on the locking element 5 in its open position, thereby holding it in the open position. This functionality may be provided in addition to or as an alternative to the holding effect of the locking elements 5 onto the locking ring 6.

The pivot axis S of the locking element 5 runs approximately in its central section and is tangential to the coupling sleeve 4. In relation to this pivot axis S, axially opposite the locking section 7, the locking element 5 has a section 11 which runs as a bevel rising axially away from the pivot axis S or has an elevation. On its inner side, at a height directly opposite the section 11 in the open position, the locking ring 6 has an elevation 12 which acts radially on the bevel or elevation of the locking element 5 when the locking ring 6 is pushed into the open position against the action of the elastic element 8.

A further fixation of the locking element 5 in the open position is achieved by at least one lever-like section 9 on the locking element 5, which section 9 extends in the circumferential direction of the coupling sleeve 4 and partially engages around it. This lever-like section 9 is latched against the coupling sleeve 4 when the coupling is in the open position. For this purpose, the coupling sleeve 4 has a latching nose 10 or latching edge on its outside, in the area where the outer end of the lever-like section 9 of the locking element 5 comes to rest in its open position, which is engaged from behind by the end of the lever-like section 9 of the locking element 5 by latching when the locking element 5 is in its open position. This is a further precaution to ensure that the coupling is held securely open as long as the plug 1 is not inserted.

During the insertion of the plug 1 into the coupling, but at the latest as soon as the plug 1 is as close as possible to the end of the pipe 3 or the hose in the position shown in FIG. 2, the latching of the locking element 5 and the coupling sleeve 4 or locking ring 6 is released and the locking element 5 moves into its locking position and then exerts the desired holding effect on the plug 1.

The locking mechanism between the lever-like section 9 of the locking element 5 and the coupling sleeve 4 is released during the insertion of the plug 1 by the lever-like section 9, which projects into the insertion path of the locking shoulder or locking edge 2 of the plug 1 distant from the locking section 7, being released from the locking position by the locking shoulder or locking edge 2 at the latest when the plug 1 is fully inserted and being carried downwards towards the end of the pipe. This position is shown in FIG. 2. The latching shoulder or latching edge 2 projects through a recess 32, which is formed in the area of the outermost end of the lever-like section 9 of the locking element 5 in the wall of the coupling sleeve 4, or this section 9 projects with a radially protruding projection through the recess 32 towards the plug 1. The latter embodiment offers the advantage that the recess 32 forms a positive guide for the lever-like section 9.

In this locking position in FIG. 2, an axially extending locking section 7—which is located in a recess in the coupling sleeve 4 in FIG. 2 and is therefore not visible—of the locking element 5 is pivoted towards the plug 1. The locking section 7 engages behind the latching shoulder or latching edge 2 of the plug 1 with a radially inward-facing latching edge. As a result, the outer side of the locking section 7 with its latching nose 18 is also shifted towards the inside of the coupling sleeve 4 in the locking position to such an extent that the radially outer boundary of the locking section 7 lies completely inside the inner side of the locking ring 6. The locking ring 6 may thus be shifted axially in relation to the coupling sleeve 4 without hindrance. In particular, the locking ring 6 may be shifted away from the end of the pipe 3 towards the plug 1 by the action of the elastic element 8, covers the latching nose 18 in the end position of the axial shifting and thereby holds the locking element 5 in the locking position.

FIG. 3 shows an alternative embodiment of a coupling with two locking elements 5 opposite each other in the circumferential direction. The lever-like sections 9 run towards each other in the circumferential direction. Adjacent recesses 32, which are formed in the wall of the coupling sleeve 4 in the region of the outermost end of the lever-like section 9 of the locking element 5, guide these lever-like sections in the same way as already explained in connection with FIGS. 1 and 2. In all cases, this secures the position of the locking element 5 and also supports pivoting about the tangential axis S.

FIG. 4 shows a partial sectional side view corresponding to FIG. 1 of a further embodiment of a coupling according to the invention, which is now used in particular for tight and releasably lockable connections of media-carrying lines in accordance with the specifications of the SAE (Society of Automotive Engineers).

In order to offer the possibility of locking the plug 1 in the coupling sleeve 4 by means of fewer contact points on the plug 1, it is provided for circumferentially adjacent locking elements 5, preferably evenly distributed in the circumferential direction, that the outermost ends of the lever-like sections 9 overlap each other in the circumferential direction. In each case, a contact point on the plug 1 may act on two locking elements 5 through a recess 32 in the coupling sleeve 4. Alternatively, a radial projection on the lever-like section 9 of a locking element 5 may project through the recess 32 into the path of a radially protruding contact point on the plug 1 in order to be pivoted from the open position shown in FIG. 4 into the locking position corresponding to the VDA version in FIG. 2. Due to the overlapping arrangement of the sections 9 of the locking elements 5, two adjacent locking elements 5 are actuated simultaneously.

FIG. 4 shows a special embodiment with only two locking elements opposite each other in the circumferential direction, which can be pivoted together by means of only one contact point on the plug 1 in order to lock the plug 1 in the coupling sleeve 4.

FIG. 4 also shows a slightly different way in which the locking ring 6 acts on the locking element 5. While the locking ring 6 according to FIGS. 1 and 2 only has a narrower inner shoulder in order to provide an annular engagement surface for the elastic element 8, a corresponding shoulder 14 is formed radially further inwards than is required for this function of supporting the elastic element 8.

With the innermost edge area of the shoulder 14, the locking ring 6 in its lowest position, the position closest to the end of the pipe 3 or hose, the open position, acts on a radial projection 13 at the lower end of the locking element 5 and presses this projection 13 in an axial direction towards the pipe 3. The locking element 5 is thus pivoted about the tangential pivot axis S and the upper locking section 7 with the inner latching nose oriented towards the plug 1 and the outer latching nose 18, which in the open position projects radially beyond the upper edge of the locking ring 6 and thus holds it in the open position assumed against the action of the elastic element 8 and thus the open position of the entire coupling arrangement, is pivoted radially outwards. Although not all locking elements 9 would have to have such a projection 13 due to the overlapping of the lever-like sections 9 of adjacent locking elements 5, this is nevertheless advantageous due to the balanced force introduction and the balanced reaction force on the locking ring 6.

Common to both embodiments, both the VDA coupling of FIGS. 1 to 3 and 7 and the SAE coupling of FIGS. 4 to 6, is a preferred configuration of the outside of the coupling sleeve 4 in order to define the pivot axis S of the locking element 5. For this purpose, a discrete radial elevation 27 is arranged as a pivot point on the outer wall of the coupling sleeve 4 at the height of the central section of the locking element 5. The central section of the locking element 5, adjacent to the locking section 7 with its latching nose 18, rests with its inner side against the elevation 27, which thus defines the pivot axis S of the locking element 5. Instead of discrete protrusions distributed around the circumference of the coupling sleeve 4 at the positions of the locking elements 5, a circumferential ridge-shaped protrusion could also be provided.

FIG. 8 shows the front end of a pipe 3 of an embodiment according to the invention, which is configured for connection to a coupling sleeve 4, as shown, for example, in FIG. 9.

The coupling sleeve 4 is again placed on the front end of the pipe 3 as a separate component, as already explained above, and is preferably fixed there by a latching connection with latching edges 16 on the coupling sleeve and latching noses 17 on the pipe end. The at least one radially inwardly projecting latching nose or latching edge 16 is also configured here at the lower end of at least one elastically radially deflectable snap hook 24 and engages behind an undercut 17 or a limited latching projection on the pipe 3 or hose and thus fixes the coupling sleeve 4 in the axial direction. The details of this latching connection are preferably configured in accordance with the features already explained above, preferably also with an rotation lock with guide ridges 26 running in the longitudinal direction of the pipe 3, which interact with guide gaps 27 configured between the adjacent snap hooks 24. The locking ring 6 according to the embodiment shown in FIG. 10 again has on its inside at least one projection 12 per locking element 5—as shown in FIG. 11—which interacts with the latter, at least when the locking ring 6 is pushed into the open position against the action of the elastic element 8. A snap arm 28 is arranged adjacent to this elevation in the circumferential direction, with a radially elastically deflectable free end 29, which is configured at the end of the snap arm 28 facing the plug 1. If necessary, the snap arm 28 may be pivoted elastically in its entirety about a tangential axis in order to deflect the free end 29 radially.

When the locking ring 6 is in its maximum retracted position, in which the coupling is in the open or unlocked state, the free end 29 of the snap arm 28 is supported directly on the coupling sleeve 4. For this purpose, at least one latching edge 30 oriented towards the pipe 3 is configured on the coupling sleeve 4.

In the embodiment shown first in FIGS. 1 to 7, the locking element 5 is supported at the end of the lever-like sections 9 against pivoting (locking) onto the plug 1 and the spring-loaded locking ring 6 is locked by the locking element 5 until it is unlocked by the plug 1 when it is inserted into the coupling sleeve 4. The locking element 5 is relieved by the support provided by the snap arm 28 on the coupling sleeve 4 and does not have to additionally support the locking ring 6, and the coupling is secured against unintentional release without the plug 1 being inserted.

FIG. 12 shows a longitudinal section in a plane through the central section of the locking elements 5, showing a state in which the plug 1 is not yet fully inserted. The plug 1 does not yet act on the locking elements 5, which do not yet engage behind the latching edge 2 on the plug 1. FIG. 13 shows a longitudinal section through the arrangement of FIG. 12, but now in a plane rotated about the longitudinal axis, which runs through a snap arm 28. Its free end 29 is supported on the locking edge 30 of the coupling sleeve 4 and holds the locking ring 6 in its rear open position against the action of the compression spring 8. A holding effect by the locking elements 5 is not required here, but may be provided for additionally securing according to a further embodiment.

When the plug 1 is fully inserted—as shown in FIG. 14—the lever-like section 9 of the locking element 5 is lifted radially outwards by the plug 1, so that the locking element 5 acts on the snap arm 28 in a radial outward direction, preferably by means of the lever-like section 9. The free end 29 of the snap arm 28 is thus also deflected outwards, pressed out of the support on the coupling sleeve 4, i.e. brought out of engagement with the latching edge 30 of the coupling sleeve 3. This unlocks the arrangement, after which the locking element 5 may be lifted via the latching nose 10 and pivoted in to lock the plug 1, and the locking ring 6 may now also be shifted axially in the direction of the plug 1 into the closed or locking position. Preferably, this shift is caused by the action of the compression spring 8 on the locking ring 6.

As may also be seen in the longitudinal section of FIG. 15, if the coupling sleeve 4 is configured accordingly with a further latching edge 31 closer to the insertion opening, the snap arm 28 may also have the additional function of axially securing the locking ring 6 even when the coupling is closed or locked.

In all embodiments according to the invention, as many components as possible consist at least predominantly of plastic. This applies in particular to the coupling sleeve 4, the locking element 5 and the locking ring 6. It is also conceivable to manufacture the elastic element 8 from elastically deformable plastic and with the required spring constant.

The embodiment examples show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions may be taken from the description.

List of reference signs

| | |
|---|---|
| 1 | plug |
| 2 | latching edge |
| 3 | pipe |
| 4 | coupling sleeve |
| 5 | locking element |
| 6 | locking ring |
| 7 | locking section |
| 8 | elastic element |
| 9 | lever-type section |
| 10 | latching nose |
| 11 | elevation/bevel |
| 12 | elevation |
| 13 | radial projection |
| 14 | shoulder |
| 15 | end section |
| 16 | latching edge |
| 17 | undercut |
| 18 | latching nose |
| 19 | upper edge |
| 20 | upper circumferential edge section |
| 21 | gasket |
| 22 | cam |
| 23 | recess |
| 24 | snap hook |
| 25 | collar |
| 26 | guide ridge |
| 27 | elevation |
| 28 | snap arm |
| 29 | free end of the snap arm |
| 30 | latching edge of the coupling sleeve |
| 31 | additional latching edge of the coupling sleeve |
| 32 | recess |
| S | swivel axis |

1: A reversibly releasable coupling for a plug-in connection on pipes (3) and hoses, for connection to a tubular plug (1) which has at least one latching shoulder or latching edge (2) running at least partially around the outer circumference, which is preferably formed from a bevel rising from the outer circumference on the plug side and a latching surface adjoining therebehind with respect to the outer circumference on the plug side, comprising at least one coupling sleeve (4) arranged on the pipe (3) or hose, at least one locking element (5) and a locking ring (6) engaging around the coupling sleeve (4), wherein the locking element (5) assumes a locking position (FIG. 2) when the plug (1) is fully inserted, in which an axially extending locking section (7) of the locking element (5) is pivoted towards the plug (1) and engages behind the latching shoulder or latching edge (2) of the plug (1) with a radially inwardly pointing latching edge in a fixing manner, and wherein the outer side of the locking section (7) in the locking position is shifted towards the inside of the coupling sleeve (4) to such an extent that it lies inside the locking ring (6) and the latter is axially released, and wherein the locking ring (6) can be moved axially by at least one elastic element (8) from an open position (FIG. 1, FIG. 3) into a locking position (FIG. 2) completely overlapping the locking section (7) as soon as the locking element (5) is in the locking position, wherein the locking element (5) is adjustable relative to the coupling sleeve (4) between an open position (FIG. 1, FIG. 3) and the locking position (FIG. 2) and has at least one lever-like section (9) which extends from the locking element (5) and is latched relative to the coupling sleeve (4) in the open position, wherein the lever-like section (9) projects into the insertion path of the latching shoulder or latching edge (2) on the plug (1) distant from the locking section (7) and is released from the latched position at the latest when the plug (1) is fully inserted.

2: The coupling according to claim 1, wherein the locking element (5) can be pivoted about a tangential pivot axis(S) relative to the coupling sleeve (4) between an open position (FIG. 1, FIG. 3) and the locking position (FIG. 2).

3: The coupling according to claim 2, wherein the pivot axis(S) of the locking element (5) lies in its central section and the section (11) opposite the locking section (7) with respect to this pivot axis(S) has a bevel or elevation, and in that wherein the locking ring (6) has an elevation (12) on its inner side which acts radially on the bevel or elevation of the locking element (5) when the locking ring (6) is pushed into the open position against the action of the elastic element (8).

4: The coupling according to claim 2, wherein the pivot axis(S) of the locking element (5) lies in its central section and the section (11) opposite the locking section (7) with respect to this pivot axis(S) has a projection (13) projecting radially outwards, and in that wherein the locking ring (6) has a shoulder (14) on its inner side which acts axially on the projection (13) when the locking ring (6) is pushed into the open position against the action of the elastic element (8).

5: The coupling according to claim 1, wherein the lever-like section (9) extending from the locking element (5) runs in the circumferential direction of the coupling sleeve (4).

6: The coupling according to claim 1, wherein the coupling sleeve (4) has a latching nose (10) or latching edge on the outside, and the lever-like section (9) engages behind this latching nose (10) or latching edge in the open position of the locking element (5).

7: The coupling according to claim 1, wherein the locking ring (6) in its open position (FIG. 1, FIG. 3) acts on the locking element (5) and holds it in the open position, and/or in that wherein the locking element (5) in its open position holds the locking ring (6) in its open position.

8: The coupling according to claim 7, wherein the locking element (5) preferably engages behind the upper edge (19) of the locking ring (6) in the open position with a locking nose (18) pointing radially outwards at the height of the locking section (7) or engages in openings in the upper, circumferential edge section (20) and axially fixes the locking ring (6).

9: The coupling according to claim 1, wherein at least two locking elements (5) are preferably evenly distributed around the circumference of the coupling sleeve (4), wherein the lever-like sections (9) of adjacent locking elements (5) overlap with their end sections (15).

10: The coupling according to claim 1, wherein an elevation (27) is arranged on the coupling sleeve (4) at the height of the central section of the locking element (5), against which elevation the inside of the central section of the locking element (5) abuts and which thus defines the pivot axis(S).

11: The coupling according to claim 1, wherein there is a latching connection (16, 17) between the coupling sleeve (4) and the pipe (3) or hose.

12: The coupling according to claim 11, wherein at least one latching edge (16) is configured on the coupling sleeve (4) and engages behind an undercut (17) on the pipe (3) or hose.

13: The coupling according to claim 11, wherein a rotation lock is provided between the pipe (3) or hose and the coupling sleeve (4).

14: The coupling according to claim 1, wherein at least one snap arm (28) is arranged on the locking ring (6), the free end (29) of which arm facing the plug (1) can be elastically deflected radially outwards, wherein the free end (29) is supported on a latching edge (30) of the coupling sleeve (4) in the open position of the locking ring (6), and wherein the free end (29) is brought out of engagement with the coupling sleeve (4) by the locking element (5) in the locking position of the locking element (5).

15: The coupling according to claim 14, wherein the coupling sleeve (4) has at least one latching edge (30) pointing towards the pipe (3) for supporting the free end (29) of the snap arm (28), and in that wherein the snap arm (28), in its open position, holds the locking ring (6) in its open position.

16: The coupling according to claim 1, wherein the coupling sleeve (4), the locking element (5) and the locking ring (6), optionally also the elastic element (8), are made at least predominantly of plastic.
